(19) United States
(12) Patent Application Publication
(10) Pub. No.: US 2021/0048810 A1
(43) Pub. Date: Feb. 18, 2021

(54) METHOD AND SYSTEM WITH A SENSOR

(71) Applicant: SICK AG, Waldkirch (DE)

(72) Inventors: Daniel HOFSTÄTTER, Waldkirch (DE); Andreas ESSLINGER, Waldkirch (DE)

(21) Appl. No.: 16/989,042

(22) Filed: Aug. 10, 2020

(30) Foreign Application Priority Data
Aug. 13, 2019 (DE) 102019121800.4

(51) Int. Cl. G05B 23/02; G06Q 50/04

(52) U.S. Cl. CPC G05B 23/0283; G06Q 50/04

(57) ABSTRACT

A method and system having a sensor, wherein the sensor has a sensor housing having at least one electronic systems, with at least one control and evaluation unit and at least one primary sensor element and at least one mechanical component, wherein the sensor has at least one additional secondary sensor element for the detection of environmental influences, wherein a digital twin sensor is provided that is related to the sensor, wherein the digital twin sensor is stored in a database, wherein the digital twin sensor forms a data model of the sensor, wherein the sensor and the digital twin sensor are connected one to another via an interface, wherein data can be transmitted at least from the sensor to the digital twin sensor via the interface.

The present invention relates to a system with a sensor in accordance with the preamble of claim 1.

Sensors in industrial plants are frequently subjected to challenging environmental conditions, such as dirt, heat and/or vibrations. These influences in time bring about a contamination, an ageing and/or a defect of the sensor. A detection quality of the sensors degrades more or less quickly. In the extreme case the reduction of the detection quality results in partial failure or failure of a plant in which the sensors are used.

In order to avoid an outage of the plant fixed maintenance cycles are frequently planned in which the state of the sensors is checked or the sensors are preventively exchanged.

In order to avoid this and to monitor the current detection quality of the sensors key figures, such as ‘quality of run’ or ‘quality of teach’ are queried from the sensor. In this respect frequently the amplitude of the input signal is evaluated and possibly compared to values of the past.

It is an object of the invention to monitor a current detection quality of sensors, to make a statement on the future detection quality and/or to provide indications of a main cause of the loss of a detection quality.

In accordance with claim 1 this object is satisfied by a system having a sensor, with the sensor having a sensor housing and at least one electronic system that has a control and evaluation unit and at least one primary sensor element and at least mechanical components, wherein the sensor has at least one additional secondary sensor element for the detection of environmental influences, wherein a digital twin sensor is provided that is related to the sensor, wherein the digital twin sensor is stored in a database, wherein the digital twin sensor forms a data model of the sensor, wherein the sensor and the digital twin are connected one to another via an interface, wherein data can be transmitted at least from the sensor to the digital twin sensor via the interface.

The at least one secondary sensor element measures environmental parameters. Additionally internal key figures, such as, e.g., a current drain, applied voltages and/or input signals, can be stored in a memory of the sensor.

At the point of time of the sensor production is not only the physical sensor produced, but rather also the digital twin sensor. The digital twin sensor is a data model and/or a simulation model of the real sensor. The digital twin sensor obtains at least all production specific pieces of information such as exact comparison values and alignment values.

In this way it is ensured that the digital twin sensor is an as exact as possible model of the produced sensor.

Deviations between the digital twin sensor and the real sensor can be determined in the real sensor or in the digital twin sensor thereby that a comparison between the real sensor and the digital twin sensor is carried out via interface.

Having regard to the interface it can for example be an ethernet interface or an ethernet connection. However, also other interfaces are possible. For example the interface can be a bus system. Optionally the interface can be a bus system. Optionally the interface is configured as a secure interface, in particular as a fail-safe interface. It can in particular be a fail-safe bus system. The interface can also be a radio interface. The interface is a remote data interface, since the sensor and the digital twin sensor are spatially separated from one another. In this way the database having the digital twin sensor is frequently stored in a data processing sensor remote from the sensor.

In an embodiment of the invention a software of the database is configured to carry out a simulation of the digital twin and the simulation carried out by the software simulates a quality of the detection function and compares this to the quality of the detection function of the sensor.

In this connection a sensor stimulation is simulated and an amplitude of a resulting input signal is simulated and compared to values of calculated input signals of the past.

If the input signal is beneath a certain pre-defined threshold then a reduced detection quality is registered.

On installing and in operation the real sensor provides, for example, the following data to the digital twin sensor via a secure data line:
current parameterizations, such as set switching points,
internal key figures, such as power consumption, input signals, and/or output currents,
environmental conditions.

With this data, the knowledge of the sensor design, the sensor assembly and/or the sensor construction and manufacturer's specifications on the used components, critical and non-critical components can be identified in the sensor system, in that the impacts of the use conditions are simulated in the digital twin sensor with respect to the most critical system components.

In an embodiment of the invention the simulation considers and simulates the simulation at least of an ageing of the sensor.

In this connection at least manufacturer's specifications on the used components of the sensors are taken as a basis. Due to, for example, statements in data sheets on used components and/or materials and database values on changes of parameters of the components and/or materials due to ageing, the ageing of the of the sensor can be simulated at certain time intervals. In this way an ageing can be simulated by way of example in weeks, months or years.

In an embodiment of the invention a result of the simulation is at least an identification of a weakest component of the sensor.

In this connection manufacturer's specifications on the used components of the sensor are taken as a basis. Due to, for example, statements in data sheets on used components and/or materials and database values on changes of parameters of the components and/or materials due to environmental conditions, a particular weakening of individual components of the sensor can be simulated. If the components are, for example, a part of a critical path of the sensor and if the weakening of the component is at most in comparison to other components, then this component is identified and stored as the weakest component.

In an embodiment of the invention a result of the simulation is at least a time up until which the weakest component of the sensor will fail.

In this connection manufacturer's specifications on the used components of the sensor are taken as a basis. Due to, for example, statements in data sheets on used components and/or materials and database values on changes of parameters of the components and/or materials due to, for example, environmental conditions, a weakening of individual components of the sensor can be simulated. In this connection a temporal progression of the weakening is determined, whereby a time up until which the component will fail can be determined.

In an embodiment of the invention a result of the simulation is at least an identification of a value of at least one secondary sensor element which correlates with the failure of a component.

In this connection manufacturer's specifications on the used components of the sensor are also taken as a basis. Due to, for example, statements in data sheets on used components and/or materials and database values on changes of parameters of the components and/or materials due to, for example, environmental conditions, a weakening of individual components of the sensor can be simulated. In this connection detected environmental conditions of a certain secondary sensor element are identified which correlate with a failure of the components. For example, increased mechanical loads that act on the sensor are correlated with a change of optical sensor properties due to occurring tensions and/or strains of optics or also damages of optical parts.

In an embodiment of the invention the secondary sensor elements are temperature sensors, position sensors, pressure sensors and/or acceleration sensors.

Temperature sensors, for example, detect the environmental temperature, the internal temperature and/or the core temperature of the individual sensor components. Thereby a temperature model of the sensor can be formed, and high temperature differences, temperature peaks and temperature sinks can be identified.

Position sensors detect the position of the sensor in space, as well as a change of the position in space. Thus, for example, a loose attachment of the sensor can be recognized simply in that the position of the sensor changes over a period of time.

Acceleration sensors detect a movement and/or a change of movement in space. Thus, for example a mechanical load, such as for example vibrations or oscillations can be identified in the sensor. For example, if resonances occur then an increased danger of a damage of the sensor can exist and can be identified.

Pressure sensors detect a pressure on sensor components or also a change in pressure on sensor components. Thus, for example, changes in pressure in the chemical process industry which act directly on the sensor or on the sensor housing can be detected and non-typical changes in pressure or pressure loads can be identified. For example, also strain sensors could be used as secondary sensor elements.

In an embodiment of the invention the data model comprises at least production specific pieces of information on the sensor, namely comparison values and/or alignment values.

These values are frequently specific for each individually produced sensor. A change of the comparison values and/or alignment values is monitored and a change can negatively influence the sensor capability directly.

In an embodiment of the invention the sensor and the digital twin sensor each have an unambiguous identification number which are linked with one another in order to unambiguously associate the digital twin sensor with the sensor and/or the sensor with the digital twin sensor.

Both sensors, the real sensor and the virtual digital twin sensor are assigned an unambiguous identification number in order to securely connect the sensor and its model.

Thereby a plurality of sensors can be differentiated from one another. Thereby also a statistic can be administrated for each sensor and an increase of causes of errors can be identified.

For example, if the optical reception values for a large number of sensors changes in a certain spatially localizable region of a production plant, then a changed illumination situation can be identified in this region that can, for example, have an impending negative effect on the detection behaviour of the sensor. Starting from this warnings or even indications for the removal of the specific failure can be output.

In an embodiment of the invention the data of the sensor are continuously transmitted or transmitted at fixed intervals to the digital twin sensor during an operating phase of the sensor.

Following a new installation the data can, for example, be continuously transmitted between the sensor and the digital twin sensor, as the sensor is first subjected to the environmental conditions in this time and an influence on the sensor takes place with a high probability.

In the course of operation and in dependence on the sensor and/or the place of operation a transfer can take place at fixed intervals with different spacing of, e.g. seconds, minutes, hours, days, weeks, months or years.

The more dramatic and/or frequent the changes of environmental conditions are, the more frequent a cyclic transfer of the data can take place.

In an embodiment of the invention the data are parameterizations and/or key figures of the sensor and/or secondary sensor data of the secondary sensor elements.

In an embodiment of the invention the data model comprises construction data, functional data and/or design data of the sensor.

In an embodiment of the invention the database is configured to transmit a simulation result to a human machine interface.

Thereby the simulation results can, for example, be displayed at a monitoring control stand, a remote maintenance stand or also directly at the sensor. The display can, for example, be a visual display, an optical display, a graphic display, a textual display, an acoustic display or the like. In this connection, for example, push notifications or the like can be transmitted and displayed.

The invention will be described in the following also with respect to further advantages and features with reference to the submitted drawings by means of embodiments. The Figures of the drawing show:

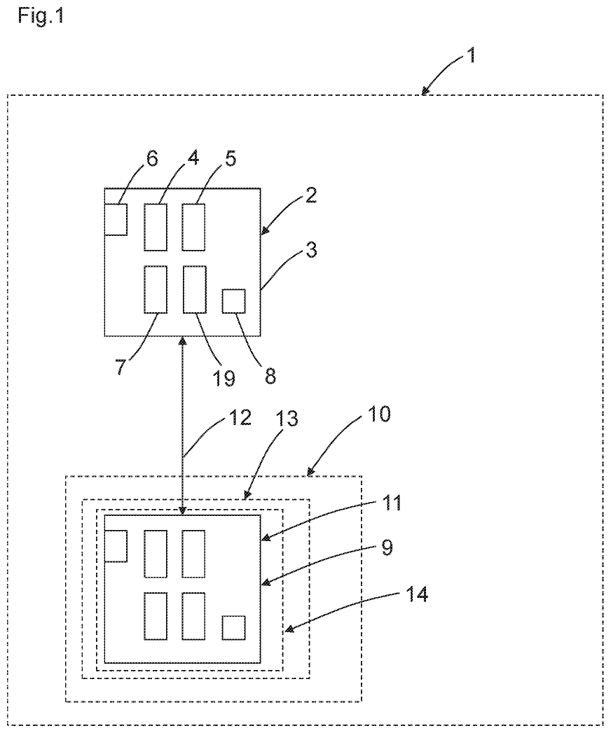

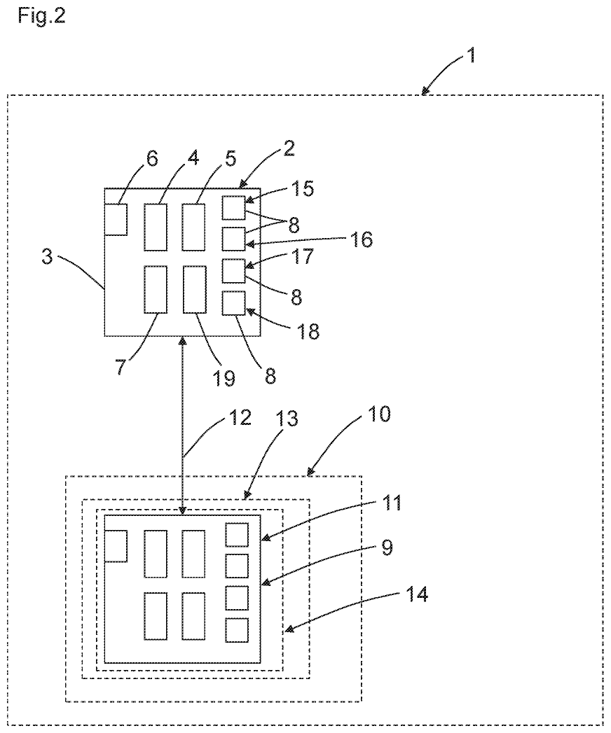

FIG. 1 and FIG. 2 a respective system in accordance with the invention with a sensor.

In the following Figures identical parts are designated with identical reference numerals.

FIG. 1 shows a system 1 with a sensor 2, wherein the sensor 2 has a sensor housing 3 with at least an electronic system 4, with at least one control and evaluation unit 5 and at least one primary sensor element 6 and at least mechanicals components 7, wherein the sensor 2 has at least one additional secondary sensor element 8 for the detection of environmental influences, wherein a digital twin sensor 9 related to the sensor 2 is provided, wherein the digital twin sensor 9 is stored in a database 10, wherein the digital twin sensor 9 forms a data model 11 of the sensor 2, wherein the sensor 2 and the digital twin sensor 9 are connected one to another via an interface 12, wherein data from the sensor 2 can be transmitted at least to the digital twin sensor 9 via the interface 12.

The at least one secondary sensor element 8 measures environmental parameters. Additionally internal key figures, such as, e.g., a current drain, applied voltages and/or input signals can be stored in a memory 19 of the sensor.

At the point in time of the sensor production, not only the physical sensor 2 is produced, but also the digital twin sensor 9. This includes all production specific pieces of information, such as exact comparison values and alignment values.

Deviations between the digital twin sensor 9 and the real sensor 2 can be determined in the real sensor 2 or in the digital twin sensor 9 thereby that a comparison between the real sensor 2 and the digital twin sensor 9 is carried out via the interface.

A system 1 with a sensor 2 serves as an example which has four critical components identified during the development.

A first critical component is an electrolytic capacitor. The probability of failure is mainly dependent on the currents that flows with ripples, the temperature of use and the topology of the circuit.

A second critical component is a switching relay. The probability of failure is mainly dependent on the maximum number of switching cycles and of the temperature of use.

A third critical component is a light emitting diode. The output power of the LED decreases in dependence on a pulsed current and an environmental temperature. If this undercuts a minimum then the sensor can no longer be operated as specified which is evaluated as a failure.

A fourth critical component is a plastic press-fit stem. In dependence on the temperature, an acceleration and an applied shear force, the plastic press-fit stem can flow or break. This can also lead to an infringement of the sensor system specifications, i.e. to a failure or to ageing effects.

The position of the capacitor in the circuit and the specific heat development at this position are known from the sensor system design. The temperature of use is detected during the use. With the aid of manufacturer's specifications, such as, for example, data sheets, the presumable remaining lifetime of the capacitor in the specific use conditions can be determined. Also a change of the capacity or of the impedance which occurs due to ageing can be simulated in this way due to the manufacturer's specifications.

The number of switching state changes that the relay carries out in a certain period of time can be detected by a counter and can be transmitted to the digital twin sensor. Besides the temperature of use also the specific temperature of use is known for the relay due to the topology determined in the sensor system design.

Also in this case the probable remaining life time of the relay can be extrapolated on use of the manufacturer's specifications in that the remaining switching state changes which the relay can still carry out in accordance with the manufacturer can be compared to the number of switching cycles in the past.

The specific temperatures of use of the light emitting diode are detected. Additionally the progression of the reduction of its output performance was measured in dependence on the temperature and the pulsed current which were measured during the component quantification. On the basis of this quantification data, the specific temperatures of use of the light emitting diode and of the known pulsed current the point in time can thus be determined at which the light emitting diode undercuts the required output power and the sensor system specification.

It the input signal decreases significantly stronger than the LED ageing envisaged by the simulation then this is evidence that the system is strongly contaminated and needs to be correspondingly cleaned. Jumps in the statistics on the input signals of the past provide an indication to the digital twin that a cleaning process is required.

From the measured accelerations and the known masses of the system components the shear forces that act on the press-fit stem can be simulated and/or calculated. The specific temperature at the press-fit stem is determined. With this data a creeping of the plastic due to ageing or the probable point in time of a break can be estimated.

If the sensor 2 is used in an environment in which it switches comparatively less, but is, however, by way of example, subjected to strong vibrations and high temperatures, then a result of the simulation can be that the plastic press-fit stem or the light emitting diode fail before the relay fails in the sensor 2 and in this way determine the point in time of the required sensor exchange. In addition to this indications can be provided that the reduction of temperature or vibrations positively influence the lifetime of the system.

In a different field of application and/or application environment with reduced vibrations, high output currents and low switching cycles, the lifetime will more likely depend on the electrolytic capacitor. Also in this context it is known that the high output current of the system is significant for the lifetime of the sensor 2.

Up to the earliest point in time of failure of a critical system component, the end of the sensor lifetime is not achieved. The duration of the sensor life cycle can thus be specifically adapted to the conditions of use and not, as is the normally the case in the state of the art, be oriented on the worst conditions of use.

The specific duration of the life cycle can thus be ensured for longer which saves resources and can minimize risks on use beyond the life time specified today.

In accordance with FIG. 1, a software 13 of the database is configured to carry out a simulation of the digital twin sensor 9 and to simulate a quality of the detection function carried out by the software 13 and to compare it to the quality of the detection function of the sensor 2.

In this connection a sensor stimulation is simulated and an amplitude of the resulting input signal is simulated and compared to values of calculated input signals of the past. If the input signal is beneath a pre-determined threshold then a reduced detection quality is notified.

On installation and in operation the real sensor 2, for example, provides the following data to the digital twin sensor via a secure data line:
current parameterizations, such as set switching points,
internal key numbers such as current drain, input signals and/or output currents,
environmental conditions.

With this data, the knowledge of the sensor design, the sensor assembly and/or the sensor construction and manufacturer's specification on the used components, critical and non-critical components can be identified in the sensor 2, in that the effects of the conditions of use on the critical sensor components are simulated in the digital twin sensor 9.

In accordance with FIG. 1 the simulation 14 considers and simulates at least an ageing of the sensor 2.

In this connection manufacturer's specifications on the used components of the sensor 2 are used as a basis. Due to, for example, datasheet statements on used components and/or materials and database values on changes of parameters of the components and/or materials due to ageing, the ageing of the sensor 2 can be simulated at certain time intervals. Thus, an ageing can, for example, be simulated in weeks, months or years.

In accordance with FIG. 1 a result of the simulation 14 is at least an identification of a weakest component of the sensor 2.

In this connection manufacturer's specifications on the used components of the sensor 2 are used as a basis. Due to, for example, datasheet statements on used components and/or materials and database values on changes of parameters of the components and/or materials due to environmental conditions, a particular weakening of individual components of the sensor 2 can be simulated. If the components are, for example, a part of a critical path of the sensor 2 and the weakening of the components is highest in comparison to other components then this component is identified and stored as the weakest component.

In accordance with FIG. 1 a result of the simulation 14 is at least an identification of a time up to a failure of the weakest component of the sensor 2.

In this connection manufacturer's specifications on the used components of the sensor 2 are used as a basis. Due to, for example, datasheet statements on used components and/or materials and database values on changes of parameters of the components and/or materials, due to environmental conditions, a particular weakening of individual components of the sensor 2 can be simulated. In this connection a temporal progress of the weakening can be determined, whereby a time up until a failure of the component can be determined.

In accordance with FIG. 1 a result of the simulation 14 is at least an identification of value of at least one secondary sensor element which correlates with the failure of a component.

In this connection manufacturer's specifications on the used components of the sensor 2 are likewise, for example, used as a basis. Due to, for example, datasheet statements on used components and/or materials and database values on changes of parameters of the components and/or materials due to environmental conditions, a weakening of individual components of the sensor 2 can be simulated. In this connection detected environmental conditions of a certain secondary sensor element are identified which correlate with a failure of the component. For example, increased mechanical loads that act on the sensor 2 can be correlated with a change of optical sensor properties due to occurring strains of optics or also damages of optical parts.

In accordance with FIG. 2, the secondary sensor elements 8 are temperature sensors 15, position sensors 16, pressure sensors 17 and/or acceleration sensors 18.

In accordance with FIG. 1 the data model 11 includes at least production specific pieces of information of the sensor, namely comparison values and/or alignment values.

These values are frequently specific to each individually produced sensor 2. A change of the comparison values and/or alignment values is monitored and a change can directly negatively influence the sensor capability.

In accordance with FIG. 1 the sensor 2 and the digital twin sensor each have an unambiguous identification number which are linked with one another in order to unambiguously allocate the digital twin sensor 9 to the sensor 2 and/or the sensor 2 to the digital twin sensor 9.

In accordance with FIG. 1 the data of the sensor 2 are continuously transmitted or transmitted at fixed intervals during an operating phase to the digital twin sensor 9.

In accordance with FIG. 1 the data are parameterization data and/or key figures of the sensor 2 and/or secondary sensor data of the secondary sensor elements 8.

In accordance with FIG. 1 the data model comprises construction data, functional data and/or design data of the sensor 2.

In accordance with FIG. 1 the database 10 or the sensor 2 are configured to transmit a simulation result to a human-machine interface.

### REFERENCE NUMERALS

1 system
2 sensor
3 sensor housing
4 electronic system
5 control and evaluation unit
6 primary sensor element
7 mechanical components
8 secondary sensor element
9 digital twin sensor
10 database
11 data model
12 interface
13 software
14 simulation
15 temperature sensor
16 position sensor
17 pressure sensor
18 acceleration sensor
19 memory

1. A system having a sensor, wherein the sensor has a sensor housing having at least one electronic system, with at least one control and evaluation unit and at least one primary sensor element and at least one mechanical component,
wherein the sensor has at least one additional secondary sensor element for the detection of environmental influences,
wherein a digital twin sensor is provided that is related to the sensor,
wherein the digital twin sensor is stored in a database,
wherein the digital twin sensor forms a data model of the sensor,
wherein the sensor and the digital twin sensor are connected one to another via an interface, wherein data can be transmitted at least from the sensor to the digital twin sensor via the interface.

2. The system in accordance with claim 1, wherein a software of the database is configured to carry out a simulation of the digital twin sensor, and the simulation carried out by the software simulates a quality of a detection function and compares it to a quality of a detection function of the sensor.

3. The system in accordance with claim 2, wherein the simulation considers and simulates at least an ageing of the sensor.

4. The system in accordance with claim 2, wherein a result of the simulation is at least an identification of a weakest component of the sensor.

5. The system in accordance with claim 2, wherein a result of the simulation is at least a time until failure of the weakest component of the sensor.

6. The system in accordance with claim 2, wherein a result of the simulation is at least an identification of a parameter of at least one secondary sensor element that is correlated with the failure of a component.

7. The system in accordance with claim 1, wherein the secondary sensor elements are temperature sensors, position sensors, pressure sensors and/or acceleration sensors.

8. The system in accordance with claim 1, wherein the data model comprises at least production specific pieces of information of the sensor.

9. The system in accordance with claim 8, wherein the specific pieces of information comprise comparison values and/or alignment values.

10. The system in accordance with claim 1, wherein the sensor and the digital twin sensor each have an unambiguous identification number that are linked to one another in order to unambiguously associate the digital twin sensor with the sensor and/or to unambiguously associate the sensor with the digital twin sensor

11. The system in accordance with claim 1, wherein, during an operating phase of the sensor, the data of the sensor is continuously transferred or transferred at fixed intervals to the digital twin sensor.

12. The system in accordance with claim 1, wherein the data are parameterization data and/or key figures of the sensor and/or secondary sensor data of the secondary sensor elements.

13. The system in accordance with claim 1, wherein the data model comprises construction data, functional data and/or design data of the sensor.

14. The system in accordance with claim 1, wherein the database is configured to transmit a simulation result to a human-machine interface.

15. A method with a sensor, wherein the sensor has a sensor housing having at least one electronic system, with at least one control and evaluation unit and at least one primary sensor element and at least one mechanical component,
wherein the sensor has at least one additional secondary sensor element for the detection of environmental influences,
wherein a digital twin sensor is provided that is related to the sensor,
wherein the digital twin sensor is stored in a database,
wherein the digital twin sensor forms a data model of the sensor,
wherein the sensor and the digital twin sensor are connected one to another via an interface, wherein data can be transmitted at least from the sensor to the digital twin sensor via the interface.
